(19) United States
(12) Patent Application Publication
(10) Pub. No.: US 2008/0184738 A1
(43) Pub. Date: Aug. 7, 2008

(54) Ceramic Finger Ring Jewelry and Method of Making Same

(76) Inventor: Steven G. Smarsh, Harrison Township, MI (US)

Correspondence Address: CARGILL & ASSOCIATES, P.L.L.C., 56 MACOMB PLACE, MT. CLEMENS, MI, 48043, US

(21) Appl. No.: 11/912,664

(22) PCT Filed: Apr. 25, 2006
(86) PCT No.: PCT/US06/15673

§ 371 Date: Oct. 25, 2007

Related U.S. Application Data
(60) Provisional application No. 60/674,646, filed on Apr. 25, 2005.

(51) Int. Cl. A44C 9/00; B23P 17/00

(52) U.S. Cl. 63/15; 29/896.412

(57) ABSTRACT

A decorative jewelry finger ring of the present invention, adapted for wearing by an individual for decoration, generally made from a tubular ceramic component. Additional embodiments may include an inner groove recessed into the inner surface of the ring, and further embodiments discloses a slip-resistant member disposed within the inner groove. A method for making finger ring jewelry generally includes cutting a finger ring workpiece off of a sintered ceramic tube by using a superhard cut off wheel; and performing post-sintering operations for forming finger ring jewelry. The new method of making a decorative jewelry finger ring is time, energy and labor saving.

### CROSS REFERENCES TO RELATED APPLICATIONS

This application claims the benefit of U.S. Provisional Patent Application No. 60/674,646 filed on Apr. 25, 2005, which is incorporated by reference herein

### BACKGROUND OF THE INVENTION

1. Field of the Invention

The present invention relates to finger ring jewelry items and methods of manufacturing the same. More particularly, the invention relates to novel finger ring jewelry made out of sintered tubular ceramic materials by using proprietary ceramic grinding technology such that the sizes of finger rings is precise and accurate.

2. Description of the Prior Art

Conventional finger ring jewelry is well known in the art, including some of the most common types of finger rings including gold, silver and platinum wedding rings and decorative rings. However, whereas such materials are relatively easy to mold, shape and polish, they are equally subject to wear, scratching and other damage detracting from their longevity, appearance and value.

More recently, ceramic materials including silicon carbide, tungsten carbide, cemented carbide, titanium carbide and high tech ceramics, which are harder than the previously mentioned precious metals, have become popular in the ring jewelry industry. Some manufacturers have pressed ceramic powders to make a ring with an outside groove such as U.S. Pat. No. 6,062,045, issued to Trent W. West, on May 16, 2000. There are several manufacturing steps, such as mixing, compressing, trimming, sintering, grinding, and polishing in this prior art reference. The ring workpieces need to be formed in a press mold individually, which is time, energy and labor consuming. Normally, the ring workpieces are shaped before being sintered. In many cases, the ring workpieces shrink unevenly during the sintering operation, yielding rings that have imprecise ring diameters. The ring manufacturers adjust and accommodate the shrinkage by making oversized ring blanks or by carefully selecting and controlling the pressure, temperate and time during the sintering operation. The problem of shrinkage, however, has not been overcome completely.

It would be of a great advantage to the ring jewelry industry if there was provided a finger ring made from previously sintered ceramic materials so that the ring can be shaped after it is sintered. The present invention seeks to provide a finger ring made of sintered tubular ceramic materials, thereby avoiding shrinkage and yielding precise ring sizing.

### SUMMARY OF THE INVENTION

In accordance with the above-noted advantages and desires of the industry, the present invention provides a finger ring jewelry item and a method of making same. This overcomes some of the aforementioned problems with the prior art because the finger rings made directly from a sintered ceramic tube already have accurate and precise sizes. It avoids the problem of shrinkage of the finger rings during the sintering operation. Compared to the prior art that requires different molds to form different shaped rings, the present invention provides that the finger ring may still be shaped with different designs after being sintered.

The finger ring of one embodiment the present invention includes an extruded tubular ceramic component with an inner groove recessed into the inner surface. Another embodiment may include a pressed power tubular ceramic component. Disclosed is also a method of making such a finger ring including (i) cutting a finger ring workpiece off of a sintered ceramic tube by using a superhard cut off wheel; and (ii) performing post-sintering operations selected from the group consisting of chamfering, forming and polishing operations suitable for forming finger ring jewelry. The method of making a finger ring decreases the complex operations and saves labor, time and energy. It is a great advantage to the ring jewelry industry to have the present invention.

Although the invention will be described by way of examples hereinbelow for specific embodiments having certain features, it must also be realized that minor modifications that do not require undo experimentation on the part of the practitioner are covered within the scope and breadth of this invention. Additional advantages and other novel features of the present invention will be set forth in the description that follows and in particular will be apparent to those skilled in the art upon examination or may be learned within the practice of the invention. Therefore, the invention is capable of many other different embodiments and its details are capable of modifications of various aspects which will be obvious to those of ordinary skill in the art all without departing from the spirit of the present invention. Accordingly, the rest of the description will be regarded as illustrative rather than restrictive.

### BRIEF DESCRIPTION OF THE DRAWINGS

For a further understanding of the nature and advantages of the expected scope and various embodiments of the present invention, reference shall be made to the following detailed description, and when taken in conjunction with the accompanying drawings, in which like parts are given the same reference numerals, and wherein:

FIG. 1 is a diagram illustrating a finger ring cut off of a sintered ceramic tube made in accordance with the present invention;

FIG. 2 is a perspective view illustrating details of a first embodiment of a finger ring made in accordance with the present invention;

FIG. 3 is a perspective view illustrating details of a second embodiment of a finger ring made in accordance with the present invention;

FIG. 4 is a cross-sectional view of the second embodiment made in accordance with the present invention;

FIG. 5 is a perspective view illustrating details of a third embodiment of a finger ring made in accordance with the present invention;

FIG. 6 is a cross-sectional view of the third embodiment made in accordance with the present invention;

FIG. 7-10 are views of various embodiments of exterior patterns to be made on the exterior ring surfaces made in accordance with the present invention;

FIG. 11 is a flow diagram illustrating the various steps followed to make a first embodiment of a finger ring in accordance with the present invention;

FIG. 12 is a flow diagram illustrating the various steps followed to make a second embodiment of a finger ring in accordance with the present invention; and

FIG. 13 is a flow diagram illustrating the various steps followed to make a third embodiment of a finger ring in accordance with the present invention.

### DETAILED DESCRIPTION OF THE INVENTION

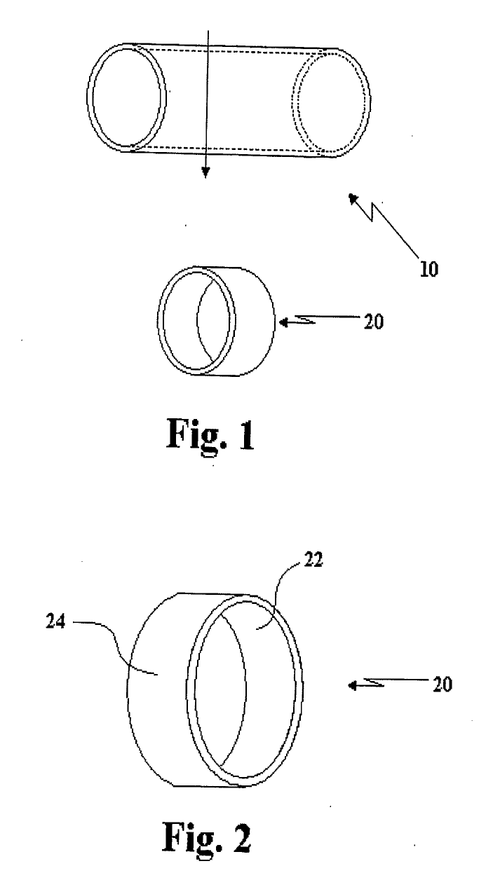

Referring now to the drawings in detail, FIG. 1 is a diagram illustrating a finger ring generally indicated by the numeral 20 as a workpiece cut off of a sintered ceramic tube generally denoted by the numeral 10 by using a superhard cut off wheel such as a diamond cut off wheel. The superhard cutting off wheel is available from grinding machine providers such as Tru Tech Systems, Inc. of Mt. Clemens, Mich. The sintered ceramic tube 10 may be made of any suitable ceramic or cermet material including silicon carbide, tungsten carbide, titanium carbide, silicon nitride, cemented carbide or any combination thereof. Generally, ceramic tube 10 preferably has a property hardness value from Vickers Hardness (HV) of from about 800 to about 2400 or from a Rockwell Hardness (HRA) value of from about 83 to about 94.5. The preferred tube 10 is from about 6 inches to about 8 inches in length and may be formed by any suitable method including extrusion, powder pressing and the like. The sintered ceramic tube 10 is generally available from ceramic products providers such as Valenite Corporation of West Branch, Mich., Kyocera Ceramic Corporation of Japan and Coors Ceramic Company of Boulder, Colo. Because finger ring workpieces are directly cut off of the extruded ceramic tubes which have been sintered, the sizes of finger ring workpieces are relatively precise and accurate. Moreover, the superhard cut off wheel is generally operated by user friendly Windows-based software so that it is also possible to make finger ring workpieces with different thickness out of one sintered ceramic tube.

FIG. 2 is a perspective view illustrating details of a first embodiment of a finger ring 20, which includes an inner surface 22 and an outer surface 24. The finger ring 20 has an inner diameter (ID) of from about ¼ inch ID to about 1 inch ID, an outer diameter (OD) of from about ⅜ inch OD to about 3/2 inches OD and a thickness of from about 1/16 inch to about 1 inch. Preferably, the finger ring 20 may have an ID of ⅝″ and an OD of ¾″. The inner surface 22 may be threaded, or otherwise ground, to make the finger ring 20 slip-resistant when worn.

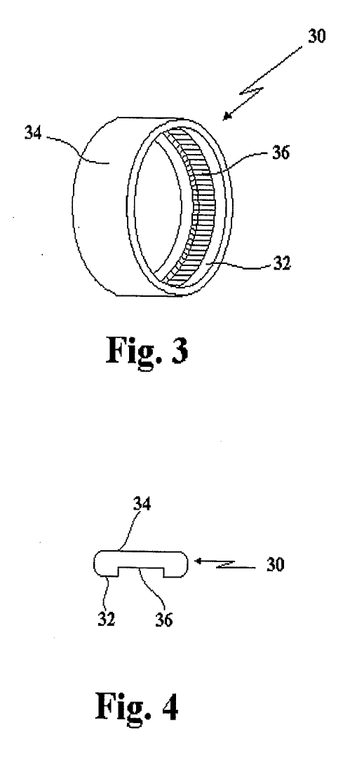

FIG. 3 is a perspective view illustrating details of a second embodiment of a finger ring 30. Finger ring 30 has an inner surface 32 and an outer surface 34. With respect to the first embodiment, the inner surface 32 further includes an inner groove 36 recessed into the inner surface 32. The inner groove 36 may be formed by a grinding wheel, such as a diamond forming wheel, a boron nitride wheel, a boron carbide wheel, a plated diamond wheel or the like. Such a grinding wheel is available from grinding machine providers such as Tru Tech Systems, Inc. of Mt. Clemens, Mich. Inner groove 36 may be circumferential and from about 1 mm to about 10 mm in width, and from about 0.1 mm to about 5 mm in depth. In addition, inner groove 36 may be threaded to make it slip-resistant and the preferred thread is a No. 8 thread ¾″.

FIG. 4 is a cross-sectional view of FIG. 3 of the second embodiment of the finger ring 30. Inner groove 36 may be disposed in the center of the inner surface 32 or any other place within inner surface 32. The alternative embodiments may have more than one inner groove with different width and depth to accommodate different sizes of fingers.

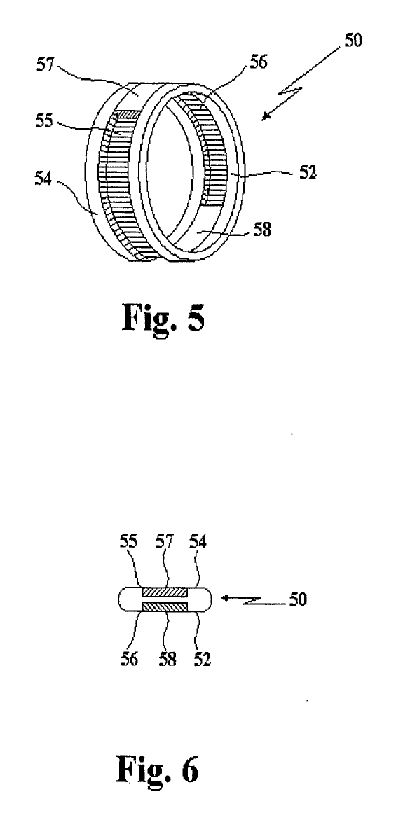

FIG. 5 and FIG. 6 illustrate details of yet a third embodiment of a finger ring generally denoted by the numeral 50. The finger ring 50 has an inner surface 52 and an outer surface 54. The inner surface 52 further includes an inner groove 56 recessed into inner surface 52 and a slip-resistant member 58 disposed within inner groove 56. The inner groove 56 may be formed by a grinding wheel which is the same as mentioned on the second embodiment. The inner groove 56 may be circumferential and from about 1 mm to about 10 mm in width, and from about 0.1 mm to about 5 mm in depth. In addition, inner groove 36 may be threaded to make it slip-resistant, with a preferred thread size of a No. 8 thread ¾″. The slip-resistant member 58 may be disposed within inner groove 56 by using well known technology, such as pressing or expanding. The slip-resistant member 58 may make the finger ring 50 slip-resistant.

The slip-resistant member 58 can be an O-ring. O-rings are one of the most slip-resistant members used in industries because they are inexpensive and easy to make, reliable, and have simple mounting requirements. Generally, o-ring selection may be based on chemical compatibility, application temperature, sealing pressure, lubrication requirements, quality, quantity and cost. The O-ring may be made from elastomeric compounds such as natural or synthetic rubber. The O-ring may also be made from other materials depending on the temperature, pressure, desired service life, tolerance and installation considerations. Furthermore, certain slip-resistant members may be expandable when it gets wet or cold to prevent the finger ring from slipping off the finger. For example, the slip-resistant member 58 can be a component made of an encapsulated member incorporating super absorbing polymer. The super absorbing polymer expands when it absorbs liquid, so that it makes the finger ring 50 slip-less when worn. Alternatively, the slip-resistant member may be a rubber band, a spring, or a sponge.

Furthermore, the outer surface 54 may include an outer groove 55 recessed into the outer surface 54 and a decorative member 57 may be disposed within the outer groove 55. The outer groove 55 may be circumferential and from about 1 mm to about 10 mm in width, and from about 0.1 mm to about 5 mm in depth. The decorative member 57 may be glued or affixed into the outer groove 55. The decorative member 57 may be selected from gold, silver, platinum, or any other soft metals, or precious stones. The alternative embodiments may have more than one inner groove and decorative member for decorative purposes.

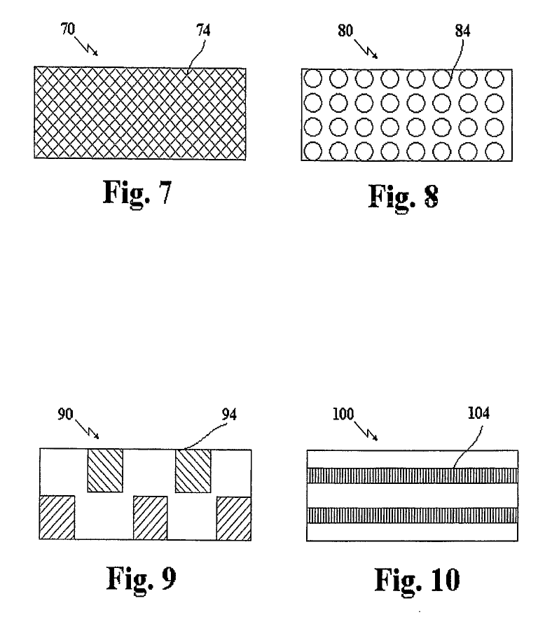

FIG. 7-10 are views of various embodiments of possible exterior patterns for finger rings 70, 80, 90 and 100 respectively. In addition to forming an outer groove and a decorative member on an outer surface of a finger ring, there are numerous other possible alternative designs including slats, slits, X-shapes, punches, 90 degree pockets, stripes and combinations thereof formed or ground into the exterior. The designs are formed on the outer surface 74, 84, 94, and 104 of the finger rings 70, 80, 90 and 100, respectively, by using a grinding wheel such as a diamond forming wheel, a boron nitride wheel, a boron carbide wheel, a plated diamond wheel, or the like. The grinding wheel may perform an operation selected from the group of forming operations including, but not limited to, grinding, plunge grinding, ID grinding, OD grinding, profile grinding or micro grinding to make various designs. A suitable grinding wheel is available from grinding machine providers such as Tru Tech Systems, Inc. of Mt. Clemens, Mich. Finally, the polishing operation completes the manufacture of the ceramic finger ring.

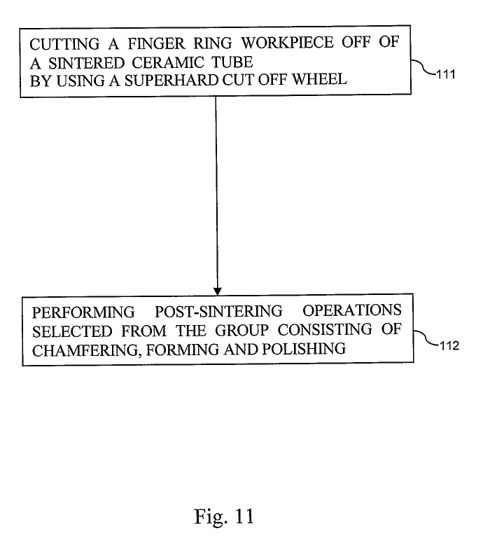

FIG. 11 is a flow diagram illustrating steps followed to make a finger ring in accordance with the first embodiment as shown in FIG. 2 of the present invention. A first step 111 of a method of manufacturing a finger ring is cutting a finger ring workpiece off of a sintered ceramic tube by using a superhard cut off wheel such as a diamond cut off wheel. The superhard cutting off wheel is available from grinding machine providers such as Tru Tech Systems, Inc. of Mt. Clemens, Mich. The ceramic tube may be from about 6 inches to about 8 inches in length and the finger ring workpiece is initially from about 1/16 inch to about 1 inch in thickness. Therefore, one sintered ceramic tube may generate from about 6 to about 128 ring workpieces with same inner diameters, outer diameters and thickness. Because finger ring workpieces are directly cut off of the extruded ceramic tubes which have been sintered, the sizes of finger ring workpieces are relatively precise and accurate. Moreover, the superhard cut off wheel is generally operated by user friendly Windows-based software so that it is also possible to make finger ring workpieces with different thickness out of one sintered ceramic tube.

For any of the embodiments of the present invention, any suitable ceramic tube may be utilized, including extruded tubes, pressed powder preforms, slip cast, lost foam cast, or any other manufacturing technique known in the art. It is best if the ceramic tube cut off piece that turns into the finger ring is uniform in ID and OD, which is best formed by extrusion, although any other conventional manufacturing method may be used.

Still referring to FIG. 11, step 112 further describes the performance of post-sintering operations suitable for forming finger ring jewelry such as chamfering, forming or polishing operations. In general, the chamfering operation is optional, although this step eases later polishing requirements. The forming operation may include making designs such as grooves, slats, slits, X-shapes, punches, 90 degree pockets, stripes and combinations thereof into the exterior. The designs are performed by using a proprietary ceramic ring forming technology including a grinding wheel. The grinding wheel may be a diamond forming wheel, a boron nitride wheel, a boron carbide wheel or a plated diamond wheel. The grinding wheel may perform operations including grinding, plunge grinding, ID grinding, OD grinding, profile grinding or micro grinding to make possibly as many different designs as desired. The grinding wheels and grinders are all available from Tru Tech Systems, Inc. of Mt. Clemens, Mich. Finally, the polishing operation completes the manufacture of the ceramic finger ring.

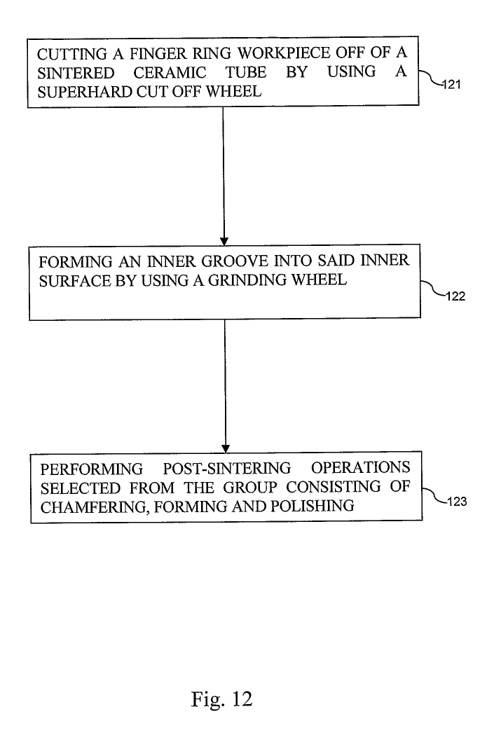

FIG. 12 is a flow diagram illustrating steps followed to make a finger ring in accordance with the second embodiment as shown in FIGS. 3 and 4 of the present invention. Step 121 accomplishes the goal of cutting a finger ring workpiece off of a sintered ceramic tube by using a superhard cut off wheel. Cutting step 121 is the same as cutting step 111 mentioned above. Step 122 describes a step of making a finger ring including forming an inner groove into the inner surface of a finger ring workpiece by using a grinding wheel. The grinding wheel may be a diamond forming wheel, a boron nitride wheel, a boron carbide wheel or a plated diamond wheel. Commonly, a plunge grinder may be used to form the inner groove in the inner surface. The inner groove may be circumferential. The grinding wheel is generally operated by user-friendly Windows-based software so that it is possible to make more than one inner groove with different lengths and depths. In addition, the inner groove may be threaded by the same grinding wheel to make the finger ring slip-resistant. Such a grinding wheel is available from Tru Tech Systems, Inc. of Mt. Clemens, Mich. A step 123 of performing post-sintering operations is the same as step 112 as mentioned in FIG. 11.

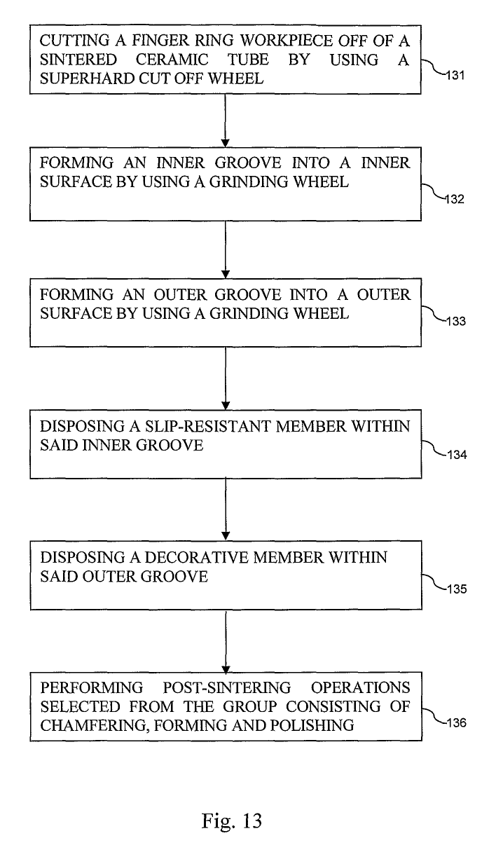

FIG. 13 is a flow diagram illustrating steps followed to make a finger ring in accordance with the third embodiment as shown in FIGS. 5 and 6 of the present invention. This is a method of manufacturing a finger ring including a grooved inner surface with a slip-resistant member and a grooved outer surface with a decorative member. Step 131 of the method shown in FIG. 13 is to cut a finger ring workpiece off of a sintered ceramic tube by using a superhard cut off wheel which is the same as mentioned above. Step 132 of the method is to form at least one inner groove into said inner surface by using a grinding wheel which is the same as mentioned above. In addition, step 133 of forming at least one outer groove into the outer surface may be performed by using the same grinding wheel for decorative purposes. The outer groove may be circumferential.

Step 134 of disposing a slip-resistant member within said inner groove is accomplished by using any conventional method, such as pressing or expanding. The slip-resistant member can be at least one O-ring. O-rings are one of the most common slip-resistant members used in industries because they are inexpensive and easy to make, reliable, and have simple mounting requirements. Generally, o-ring selection may be based on chemical compatibility, application temperature, sealing pressure, lubrication requirements, quality, quantity and cost. The O-ring may be made from elastomeric compounds such as natural or synthetic rubber. The O-ring may also be made from other materials depending on the temperature, pressure, desired service life, tolerance and installation considerations. Furthermore, certain slip-resistant members may be expandable when it gets wet or cold to prevent the finger ring from slipping off the finger. For example, the slip-resistant member can be a component made of an encapsulated member incorporating super absorbing polymer. The super absorbing polymer expands when it absorbs liquid, so that it makes the finger ring slip-less when worn.

In addition to the step 134, step 135 of disposing a decorative member into the outer groove may be performed by gluing or affixing. The decorative member may be selected from gold, silver, platinum, or any other soft metal, or precious stones. The alternative embodiments may have more than one inner groove and at least one decorative member for decorative purposes. A step 136 of performing post-sintering operations is the same as mentioned with regards to FIG. 11 and FIG. 12 hereinabove.

In summary, numerous benefits have been described which result from employing any or all of the concepts and the features of the various specific embodiments of the present invention, or those that are within the scope of the invention. The finger rings made directly from a sintered ceramic tube have accurate and precise sizes, so that it resolves the problem of shrinkage of the finger rings during the sintering operation. Compared to the prior art that requires different molds to form different shaped rings, the present invention provides that the finger ring may still be shaped with different designs after being sintered. In addition, having a slip-resistant member within the finger rings makes the finger ring slip-resistant when worn. The method of making a finger ring decreases the complex operations and saves labor, time and energy. It is absolutely of a great advantage to the ring jewelry industry to have the present invention.

The foregoing description of several preferred embodiments of the invention have been presented for purposes of illustration and description. It is not intended to be exhaustive or to limit the invention to the precise form disclosed. Obvious modifications or variations are possible in light of the above teachings with regards to the specific embodiments. The embodiments were chosen and described in order to best illustrate the principles of the invention and its practical applications to thereby enable one of ordinary skill in the art to best utilize the invention in various embodiments and with various modifications as are suited to the particular use contemplated.

### INDUSTRIAL APPLICABILITY

The present invention finds particular utility in the ring jewelry industry while it provides a finger ring made out of extruded and sintered tubular ceramic materials to avoid shrinkage and to make precise ring sizing. The new method of making a finger ring improves the manufacturing process; therefore it is time, energy and labor saving.

What is claimed is:

1. A finger ring having an inner surface and an outer surface, comprising:
a tubular ceramic component adapted for wearing by an individual for decoration,
wherein said ceramic component is selected from the group consisting of silicon carbide, tungsten carbide, titanium carbide, cemented carbide, silicon nitride and combinations thereof.

2. The finger ring of claim 1, wherein said tubular component is a tube having an inner diameter (ID) of from about ¼ inch ID to about 1 inch ID.

3. The finger ring of claim 1, wherein said tubular component is a tube having an outer diameter (OD) of from about ⅜ inch OD to about 3/2 inches OD.

4. A finger ring having an inner surface and an outer surface, comprising:
a tubular ceramic component; and
an inner groove recessed into the inner surface;
wherein said finger ring is adapted for wearing by an individual for decoration.

5. The finger ring of claim 4, wherein said tubular component is a tube having an inner diameter (ID) of from about ¼ inch ID to about 1 inch ID.

6. The finger ring of claim 4, wherein said tubular component is a tube having an outer diameter (OD) of from about ⅜ inch OD to about 3/2 inches OD.

7. The finger ring of claim 4, wherein said ceramic component is selected from the group consisting of silicon carbide, tungsten carbide, titanium carbide, cemented carbide, silicon nitride and combinations thereof.

8. The finger ring of claim 4, wherein said ceramic component has property hardness of from about Vickers Hardness (HV) 800 to 2400.

9. The finger ring of claim 4, wherein said ceramic component has a property hardness of from about Rockwell Hardness (HRA) 83 to 94.5.

10. The finger ring of claim 4, wherein said inner groove is threaded.

11. The finger ring of claim 10, wherein said inner groove has a No. 8 thread ¾″.

12. A finger ring having an inner surface and an outer surface, comprising:
a tubular ceramic component;
an inner groove recessed into the inner surface; and
a slip-resistant member disposed within said inner groove;
wherein said finger ring is adapted for wearing by an individual for decoration.

13. The finger ring of claim 12, wherein said tubular component is a tube having an inner diameter (ID) of from about ¼ inch ID to about 1 inch ID.

14. The finger ring of claim 12, wherein said tubular component is a tube having an outer diameter (OD) of from about ⅜ inch OD to about 3/2 inches OD.

15. The finger ring of claim 12, wherein said tubular component is a tube having an inner diameter (ID) of ⅝″ and an outer dimension (OD) of ¾″.

16. The finger ring of claim 12, wherein said ceramic component is selected from the group consisting of silicon carbide, tungsten carbide, titanium carbide, cemented carbide, silicon nitride and combinations thereof.

17. The finger ring of claim 12, wherein said ceramic component has property hardness of from about Vickers Hardness (HV) 800 to 2400.

18. The finger ring of claim 12, wherein said ceramic component has property hardness of from about Rockwell Hardness (HRA) 83 to 94.5.

19. The finger ring of claim 12, wherein said inner groove is threaded.

20. The finger ring of claim 12, wherein said slip-resistant member is an O-ring.

21. The finger ring of claim 12, wherein said slip-resistant member is made of an encapsulated member incorporating super absorbing polymer.

22. The finger ring of claim 12, wherein said slip-resistant member is disposed within said inner groove by pressing in place.

23. The finger ring of claim 12, wherein said slip-resistant member is disposed within said inner groove by expanding in place.

24. The finger ring of claim 12, wherein said outer surface comprises an outer groove and a decorative member, wherein the outer groove recessed into said outer surface and said decorative member disposed within said outer groove.

25. The finger ring of claim 24, wherein said decorative member is selected from the group consisting of gold, silver, platinum and other soft metals.

26. A method of manufacturing a finger ring including an inner surface and an outer surface, the method, comprising:
(a) cutting a finger ring workpiece off of a sintered ceramic tube by using a superhard cut off wheel; and
(b) performing post-sintering operations selected from the group consisting of chamfering, forming and polishing operations suitable for forming finger ring jewelry.

27. The method of claim 26, wherein said ceramic tube is from about 6 inches to about 8 inches in length.

28. The method of claim 26, wherein said finger ring workpiece is initially from about 1/16 inch to about 1 inch in thickness.

29. The method of claim 26, wherein said forming operation includes making designs selected from the group consisting of grooves, slats, slits, X-shapes, punches, 90 degree pockets, stripes and combinations thereof.

30. A method of manufacturing a finger ring including a grooved inner surface and an outer surface, the method, comprising:
(a) cutting a finger ring workpiece off of a sintered ceramic tube by using a superhard cut off wheel;
(b) forming an inner groove into said inner surface by using a grinding wheel; and
(c) performing post-sintering operations selected from the group consisting of chamfering, forming and polishing operations suitable for forming finger ring jewelry.

31. The method of claim 30, wherein said ceramic tube is from about 6 inches to about 8 inches in length.

32. The method of claim 30, wherein said finger ring workpiece is initially from about 1/16 inch to about 1 inch in thickness.

33. The method of claim 30, wherein said grinding wheel is selected from the group consisting of a diamond forming wheel, a boron nitride wheel, a boron carbide wheel and a plated diamond wheel.

34. The method of claim 30, wherein said forming operation includes making designs selected from the group consisting of grooves, slats, slits, X-shapes, punches, 90 degree pockets, stripes and combinations thereof.

35. A method of manufacturing slip-resistant finger ring jewelry including a grooved inner surface and an outer surface, the method, comprising:
(a) cutting a finger ring workpiece off of a and sintered ceramic tube by using a superhard cut off wheel;
(b) forming an inner groove into said inner surface by using a grinding wheel;
(c) disposing a slip-resistant member within said inner groove; and
(d) performing post-sintering operations selected from the group consisting of chamfering, forming and polishing operations suitable for forming finger ring jewelry.

36. The method of claim 35, wherein said ceramic tube is from about 6 inches to about 8 inches in length.

37. The finger ring of claim 35, wherein said finger ring workpiece is from about ⅛ inch to about 1 inch in thickness.

38. The method of claim 35, wherein said grinding wheel is selected from the group consisting of a diamond forming wheel, a boron nitride wheel, a boron carbide wheel and a plated diamond wheel.

39. The method of claim 35, wherein said slip-resistant member is an O-ring.

40. The method of claim 35, wherein said slip-resistant member is made of an encapsulated member incorporating super absorbing polymer.

41. The method of claim 35, further comprising an additional step of forming an outer groove into said outer surface by using a grinding wheel.

42. The method of claim 35, further comprising an additional step of disposing a decorative member within said outer groove.

43. The method of claim 35, wherein said forming operation includes making designs selected from the group consisting of grooves, slats, slits, X-shapes, punches, 90 degree pockets stripes and combinations thereof.
